(19) United States
(12) Patent Application Publication
(10) Pub. No.: US 2014/0161324 A1
(43) Pub. Date: Jun. 12, 2014

(54) ELECTRONIC DEVICE AND DATA ANALYSIS METHOD

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHIU-HUA LU, New Taipei (TW); YUE-CEN LIU, New Taipei (TW)

(73) Assignee: HON HAI PRECISION INDUSTRY CO., LTD., New Taipei (TW)

(21) Appl. No.: 14/093,046

(22) Filed: Nov. 29, 2013

(30) Foreign Application Priority Data
Dec. 7, 2012 (TW) 101146000

(51) Int. Cl. G06K 9/00; G06T 11/20

(52) U.S. Cl. CPC G06K 9/00677; G06K 9/00261; G06T 11/206
USPC 382/110

(57) ABSTRACT

In a method for analyzing interpersonal relationships of persons. The method obtains images of the persons within every preset time period, determines images from the obtained images which include a first person and a second person within every preset time period, calculates a distance between the first person and the second person in each determined image within every preset time period, to calculate a relationship weight between the first person and the second person within every preset time period. The method further determines a tendency chart of the relationship weight between the first person and the second person according to the relationship weight between the first person and the second person within every preset time period, and displays the tendency chart on a display device.

### BACKGROUND

1. Technical Field

Embodiments of the present disclosure relate to data analysis technology, and particularly to an electronic device and method for analyzing interpersonal relationships of persons in digital images.

2. Description of Related Art

Social network sites (e.g., FACEBOOK, GOOGLE+) provide image sharing function to persons. The person may upload images to the social network sites, and add tag information (e.g., names) for each uploaded image. The social network sites may help the person find their friends in a plurality of images using face detection technology. However, the social network sites cannot determine an interpersonal relationship between two persons (i.e., an association between two people that may range from short-lived to long-lasting), and cannot determine an variation tendency of the interpersonal relationship between two persons. If a person wants to know the variation tendency of the interpersonal relationship (e.g., in which years the relationship were the best) with his/her friend, the person has to look up all of the images with his/her friends in albums, to determine which years have the most images with his/her friends (a number of the images can be used to represent a period of the best relationship). Therefore, a more efficient method for analyzing interpersonal relationships of persons in digital images is desired.

### BRIEF DESCRIPTION OF THE DRAWINGS

FIG. 1 is a block diagram of one embodiment of an electronic device including a data analysis system.

FIG. 2 is a schematic block diagram of function modules of the data analysis system included in the electronic device.

FIG. 3 is a flowchart of one embodiment of a method for analyzing interpersonal relationships of persons in digital images.

FIG. 4 is a schematic diagram of a tendency chart of a relationship weight between a first person and a second person.

FIG. 5 is a schematic diagram of moving a movable time block in the tendency chart of the relationship weight between the first person and the second person.

FIG. 6 is a schematic diagram of a plurality of tendency charts of the relationship weight of a plurality of persons.

FIG. 7 is a variation chart of relationship strengths between the first person and the second person within different time periods.

FIG. 8 is a variation chart of a number of images which include both of the first person and the second person within different time periods.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

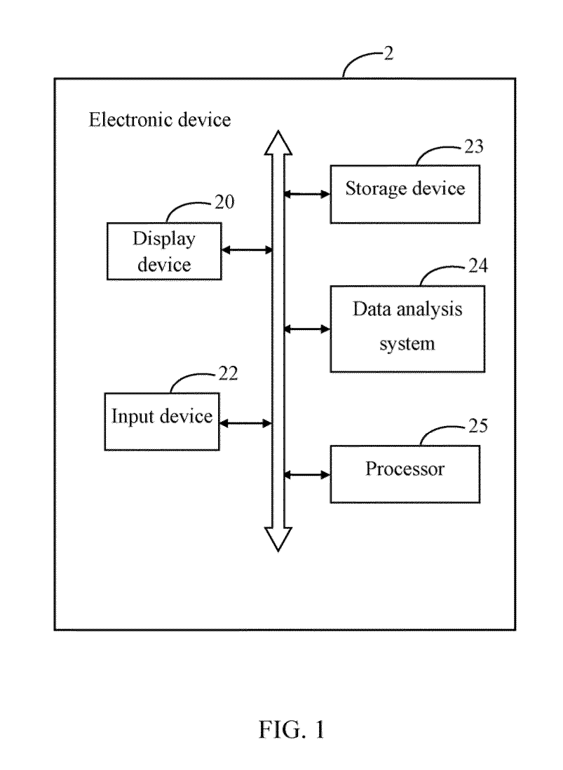

FIG. 1 is a block diagram of one embodiment of an electronic device 2 including a data analysis system 24. In one embodiment, the electronic device 2 further includes a display device 20, an input device 22, a storage device 23, and at least one processor 25. FIG. 1 illustrates only one example of the electronic device 2 that may include more or fewer components than illustrated, or have a different configuration of the various components in other embodiments. The electronic device 2 may be a computer, a mobile phone, or a personal digital assistant (PDA).

The display device 20 displays digital images (hereinafter referred to as “images”) of different persons and other digital information, and the input device 22 may be a mouse or a keyboard for data input. The storage device 23 may be a non-volatile computer storage chip that can be electrically erased and reprogrammed, such as a hard disk or a flash memory card.

In one embodiment, the data analysis system 24 is used to analyze interpersonal relationships of specified persons based on the images of the specified persons, determine a tendency chart of the interpersonal relationships of the specified persons, and display the tendency chart of the interpersonal relationship on the display device 20. The data analysis system 24 may include computerized instructions in the form of one or more programs that are executed by the at least one processor 25 and stored in the storage device 23 (or memory). A detailed description of the data analysis system 24 is given in the following paragraphs.

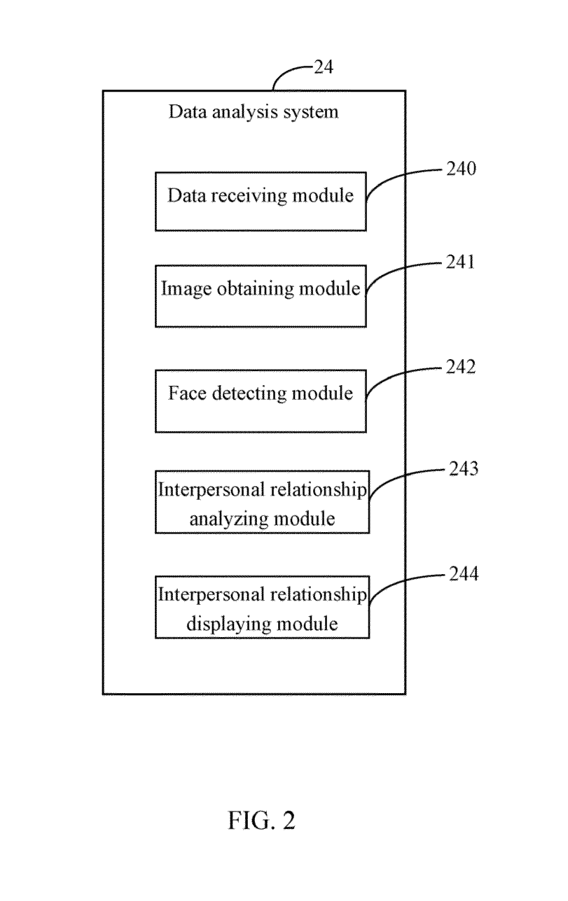

FIG. 2 is a block diagram of function modules of the data analysis system 24 included in the electronic device 2. In one embodiment, the data analysis system 24 may include one or more modules, for example, a data receiving module 240, an image obtaining module 241, a face detecting module 242, an interpersonal relationship analyzing module 243, and an interpersonal relationship displaying module 244. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

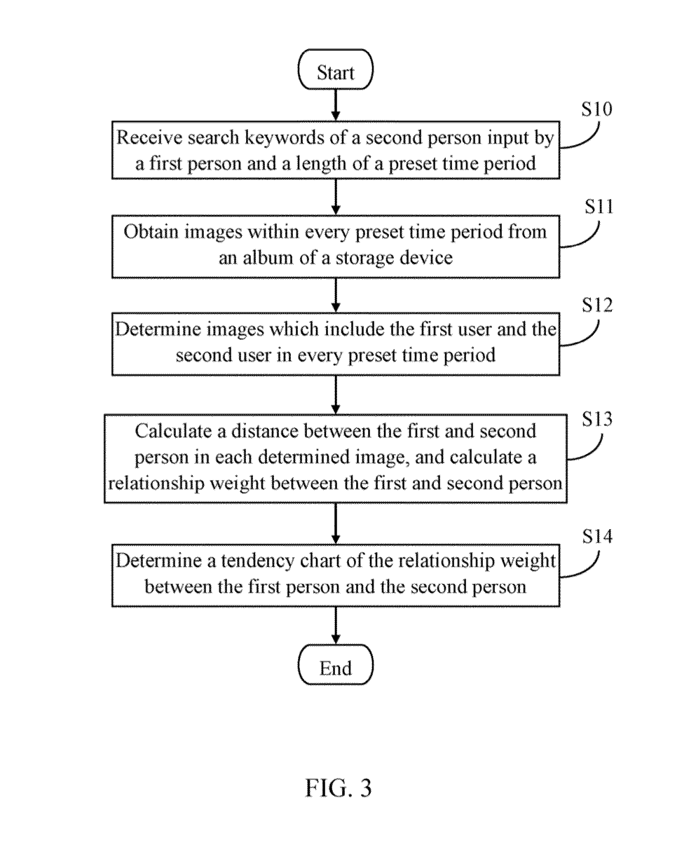

FIG. 3 is a flowchart of one embodiment of a method for analyzing interpersonal relationships of persons in digital images. Depending on the embodiment, additional steps may be added, others removed, and the ordering of the steps may be changed.

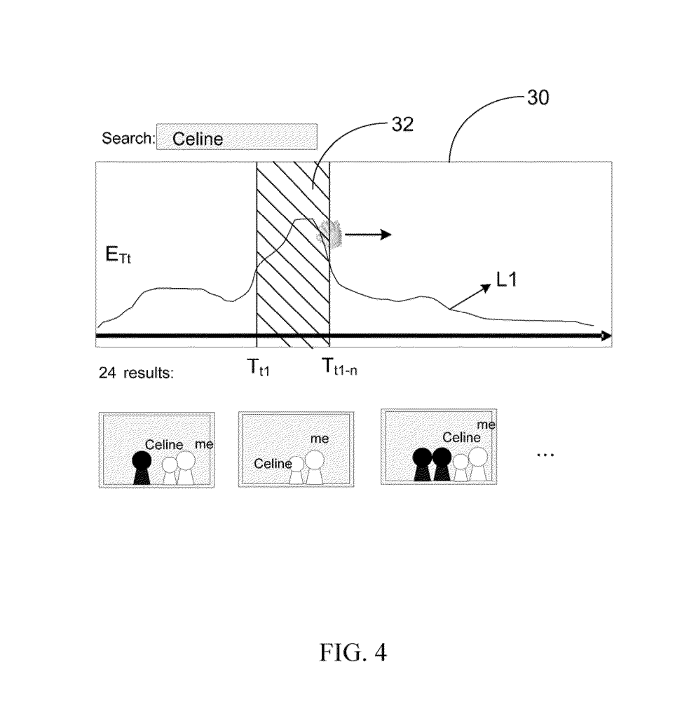

In step S10, the data receiving module 240 receives search keywords of a second person input by a first person and a time length of a preset time period for analyzing a variation tendency of an interpersonal relationship between the first person and the second person. The search keywords may be a name of the second person, the time length of the preset time period may be one week, one month, or one quarter. In one embodiment, the first person is a person who uses the data analysis system 24. As shown in FIG. 4, the first person (“me”) inputs a name “Celine” of the second person in a search bar of a social network site.

In step S11, the image obtaining module 241 obtains images within every preset time period from an album of the storage device 23. In one embodiment, each image includes a time stamp. For example, if the image includes exchangeable image file format (EXIF) information, the time recorded in the EXIF information is set as the time stamp of the image. If the image does not include the EXIF information, the time when the image is uploaded to a storage device of the social network site (upload time) is set as the time stamp of the image.

For example, if the time length of the preset time period is set as one month by the first person, the image obtaining module 241 obtains the images within every month from the album of the storage device 23 according to the time stamp of each image. For example, the image obtaining module 241 obtains ten images in January, 2012, fifteen images in February, and so on. In other embodiments, the time length of the preset time period may a default duration (e.g., one month), so that the first person does not need to set the time length of the preset time period.

In step S12, the face detecting module 242 determines images from the obtained images which include the first person and the second person within every preset time period. For example, the face detecting module 242 determines six images including the first person and the second person in January, 2012 from the ten images in January, 2012, and determines eight images including the first person and the second person in February, 2012 from the fifteen images in February, 2012.

In detail, the face detecting module 242 detects one or more face blocks in each image within every preset time period, and determines whether one image includes the first person and the second person by comparing the detected face blocks in the one image with a first face template of the first person and a second face template of the second person. In one embodiment, the first face template may be a first head portrait of the first person in the social network site, and the second face template may be a second head portrait of the second person in the social network site.

If one image includes a first face block matching the first face template of the first person and includes a second face block matching the second face template of the second person, the face detecting module 242 determines that the one image includes the first person and the second person.

In step S13, the interpersonal relationship analyzing module 243 calculates a distance between the first person and the second person in each determined image within every preset time period, and calculates a relationship weight between the first person and the second person within every preset time period according to the distance between the first person and the second person in the determined images. In one embodiment, the distance is a relative value that indicates how close two persons stand in each determined image. For example, if the first person is adjacent to the second person in one determined image, the distance between the first person and the second person is “1”, if a number of persons between the first person and the second person is “n”, the distance between the first person and the second person is “n+1”.

In detail, the interpersonal relationship analyzing module 243 obtains each determined image in every preset time period, determines a number “U” of persons included in each determined image according to the detected face blocks in each determined image, and calculates a distance “D” between the first person and the second person in each determined image.

In addition, the interpersonal relationship analyzing module 243 further calculates a relationship strength “E(n)” between the first person and the second person in each determined image according to the number “U” of persons in each determined image and the distance “D” between the first person and the second person using a preset relationship function. In one embodiment, the preset relationship function is “E(n)=1/f(U, D)”. One example of the preset relationship function is “E(n)=1/(U*D)”, where, “*” is a multiplication sign.

When the determined images within every preset time period are processed, the interpersonal relationship analyzing module 243 calculates a relationship weight between the first person and the second person within every preset time period by totaling the relationship strength “E(n)” between the first person and the second person in each determined image within every preset time period. In one embodiment, a relationship weight between the first person and the second person within every preset time period represents an interpersonal relationship between the first person and the second person within every preset time period. A formula for calculating the relationship weight between the first person and the second person is as follows.

$${E}_{Tt} ( a , b ) = {\sum }_{n = 1}^{{P}_{Tt}} \frac{1}{{U}_{n} \times {D}_{n} ( a , b )} \qquad ( 1 )$$

In the formula (I), “E_{Tt}(a,b)” represents a relationship weight between a first person “a” and a second person “b” within a preset time period “Tt”, “P_{Tt}” represents a number of determined images which include the first person “a” and the second person “b” within the preset time period “Tt”, “Uₙ” represents a number of persons included in a nth determined image within the preset time period “Tt”, and “Dₙ(a,b)” represents a distance “D” between the first person “a” and the second person “b” in the nth determined image within the preset time period “Tt”. For example, the interpersonal relationship analyzing module 243 determines that the relationship weight between the first person “a” and the second person “b” within January, 2012 is 80, and the relationship weight between the first person “a” and the second person “b” within February, 2012 is 90. In one embodiment, a higher relationship weight within one preset time period represents a better relationship between the first person “a” and the second person “b” within the preset time period.

In step S14, the interpersonal relationship displaying module 244 determines a tendency chart 30 of the relationship weight between the first person and the second person according to the relationship weight between the first person and the second person within every preset time period, and displays the tendency chart 30 on the display device 20.

For example, as shown in FIG. 4, the tendency chart 30 of the relationship weight includes a variation curve “L1” of the relationship weight (hereinafter referred to as “relationship curve”) between the first person and the second person. A horizontal axis (e.g., an X-axis) of the tendency chart 30 represents time, and a vertical axis (e.g., a Y-axis) of the tendency chart 30 represents the relationship weight “E_{Tt}” between the first person and the second person within every preset time period. Each point in the horizontal axis of the tendency chart 30 represents one preset time period “Tt”. For example, as shown in FIG. 4, “Tt1” represents a preset time period in January, 2004 (i.e., [2004 Jan. 1, 2004 Jan. 31]). The tendency chart 30 of the relationship weight in FIG. 4 shows a variation of the interpersonal relationship between the first person and the second person, such as, when the interpersonal relationship is better, and when the interpersonal relationship is estranged.

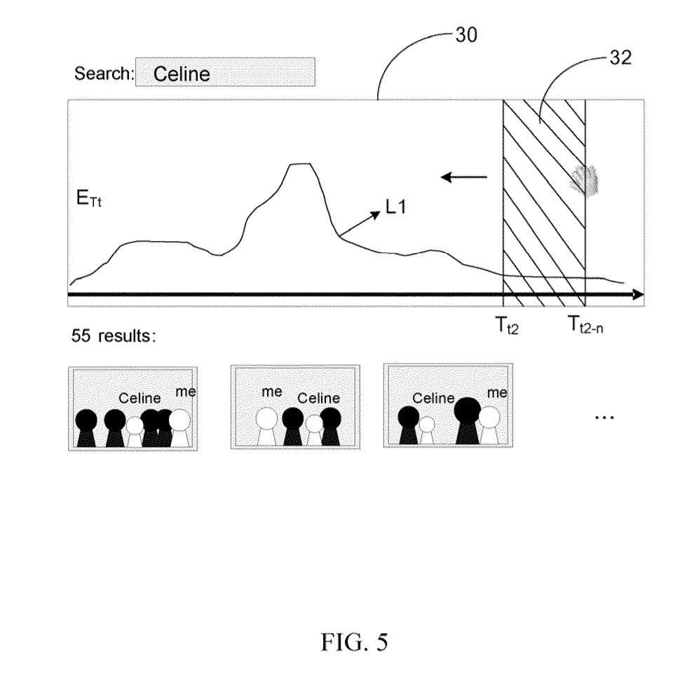

In other embodiments, the tendency chart 30 of the relationship weight may further include a movable time block 32 which may be moved along the horizontal axis of the tendency chart 30. The movable time block 32 includes one or more preset time periods and a plurality of determined images including the first person and the second person within each preset time period. As shown in FIG. 4, the movable time block 32 includes a plurality of preset time periods from “Tₜ₁” to “Tₜ₁₋ₙ.”. As shown in FIG. 5, when the movable time block 32 is moved, the movable time block 32 includes a plurality of preset time periods from “Tₜ₂” to “Tₜ₂₋ₙ”. When the movable time block 32 is moved, the interpersonal relationship displaying module 244 displays the determined images including the first person and the second person within the preset time periods corresponding to the movable time block 32 below the tendency chart 30 according to a preset sequence (e.g., an ascending order of the time stamps of the determined images). In other embodiments, a width of the movable time block 32 is adjustable (e.g., increased or decreased). For example, the movable time block 32 may be decreased to a straight line (e.g., including one preset time period).

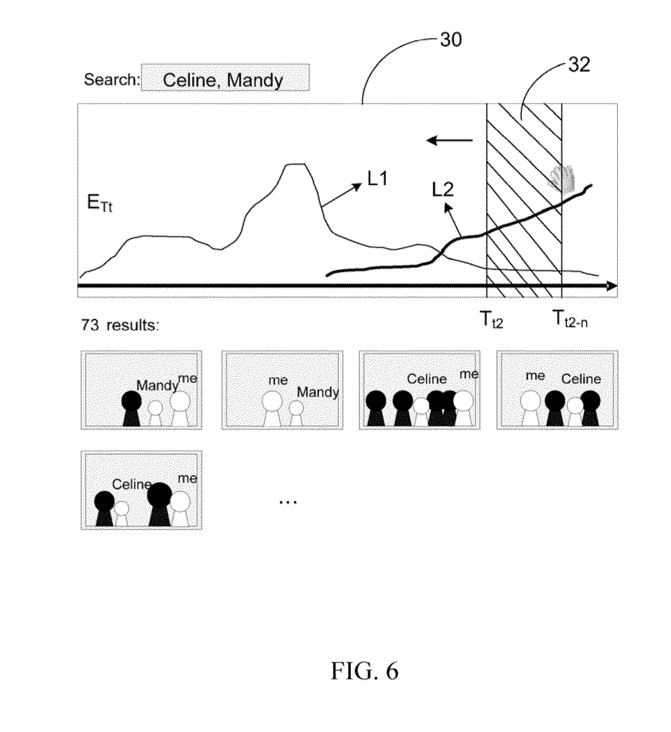

In other embodiments, the data receiving module 240 may receive search keywords of a second person and a third person (or more persons) input by a first person, where the first person is the person who uses the data analysis system 24. As shown in FIG. 6, the first person (“me”) inputs a name “Celine” of the second person and a name “Mandy” of the third person in the search bar. Thus, two relationship curves are displayed in the tendency chart 30 of the relationship weight, where a first relationship curve “L1” records a variation of the relationship weight between the first person and the second person, and a second relationship curve “L2” records a variation of the relationship weight between the first person and the third person.

In other embodiments, when the data receiving module 240 receives the search keywords of the second person and the third person input by the first person, one relationship curve which records a variation of the relationship weight between the second person and the third person may be also displayed in the tendency chart 30.

In other embodiments, the step S13 may be executed as follows. The interpersonal relationship analyzing module 243 calculates a relationship weight between the first person and the second person within every preset time period according to a number of determined images which include the first person and the second person within every preset time period. For example, a larger number of the determined images within one preset time period represents a higher relationship weight between the first person and the second person within the one preset time period (i.e., a better relationship between the first person and the second person within the one preset time period).

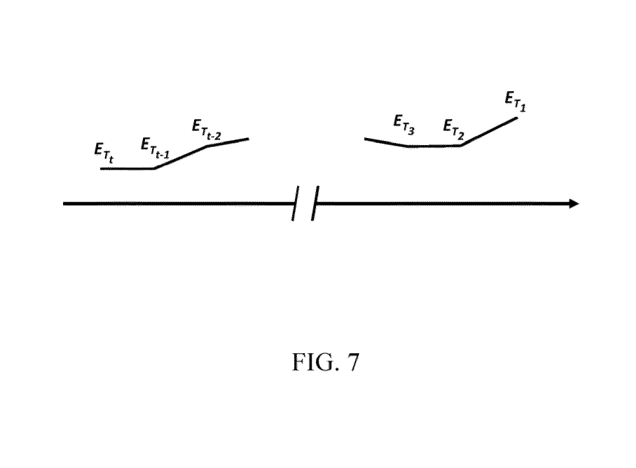

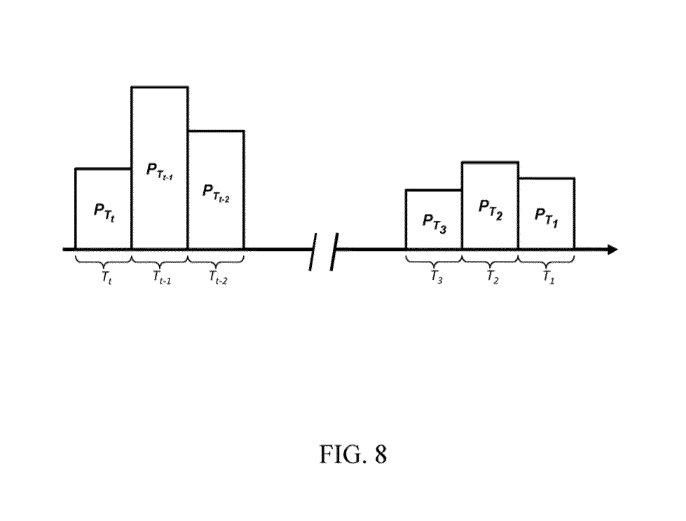

It should be noted that an accuracy of the relationship weight calculated by the distance between the first person and the second person is greater than an accuracy of the relationship weight calculated by the number of the determined images which include the first person and the second person. For example, as shown in FIG. 7, a relationship weight “E_{Tt-1}” between the first person and the second person in a preset time period “Tₜ₋₁” is lower than a relationship weight “E_{Tt-2}” in a preset time period “Tₜ₋₂”. However, as shown in FIG. 8, a number “P_{Tt-1}” of the determined images including the first person and the second person in the preset time period “Tₜ₋₁” is greater than a number “P_{Tt-2}” of the determined images in the preset time period “Tₜ₋₂”. The rectangular blocks in FIG. 8 represent the number of the determined images, a higher rectangular block represents a larger number of the determined image.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for analyzing interpersonal relationships of persons using an electronic device, the method comprising:
obtaining images of persons within every preset time period from a storage device of the electronic device;
determining images from the obtained images which comprise a first person and a second person within every preset time period;
calculating a distance between the first person and the second person in each of the determined images within every preset time period, and calculating a relationship weight between the first person and the second person within every preset time period according to the distance between the first person and the second person in the determined images; and
determining a tendency chart of the relationship weight between the first person and the second person according to the relationship weight between the first person and the second person within every preset time period, and displaying the tendency chart on a display device of the electronic device.

2. The method according to claim 1, wherein each of the images comprises a time stamp.

3. The method according to claim 2, wherein the time stamp of the image is set according to the time recorded in exchangeable image file format (EXIF) information of the image upon a condition that the image comprises the EXIF information, or set according to the time when the image is uploaded to the storage device upon a condition that the image does not comprise the EXIF information.

4. The method according to claim 1, wherein the determined images which comprise the first person and the second person are determined by:
detecting one or more face blocks in each of the images within every preset time period, and comparing the detected face blocks in each of the images with a first face template of the first person and a second face template of the second person; and
determining that one image comprises the first person and the second person upon a condition that the one image comprises a first face block matching the first face template of the first person and comprises a second face block matching the second face template of the second person.

5. The method according to claim 1, wherein the relationship weight between the first person and the second person is calculated by:
obtaining the determined images in every preset time period, and determining a number “U” of persons in each of the determined images according to detected face blocks in each of the determined images;
calculating a distance “D” between the first person and the second person in each of the determined images;
calculating a relationship strength “E(n)” between the first person and the second person in each of the determined images according to the number “U” of persons in each of the determined images and the distance “D” between the first person and the second person using a preset relationship function “E(n)=1/f(U, D)”; and
calculating a relationship weight between the first person and the second person within every preset time period by totaling the relationship strength “E(n)” between the first person and the second person in each of the determined images within every preset time period.

6. The method according to claim 5, wherein the distance between the first person and the second person is determined to be “n+1” upon a condition that a number of persons between the first person and the second person is “n”.

7. The method according to claim 5, wherein the preset relationship function is “E(n)=1/(U*D)”, and “*” is a multiplication sign.

8. The method according to claim 1, wherein the tendency chart of the relationship weight comprises a movable time block which moves along a horizontal axis of the tendency chart, and the determined images comprising the first person and the second person within the preset time periods corresponding to the movable time block are displayed on the display device according to a preset sequence when the movable time block is moved.

9. The method according to claim 8, wherein a width of the movable time block is adjustable.

10. The method according to claim 1, further comprising: calculating a relationship weight between the first person and the second person within every preset time period according to a number of determined images which include the first person and the second person within every preset time period.

11. An electronic device, comprising:
a processor;
a storage device storing a plurality of instructions, which when executed by the processor, causes the processor to:
obtain images of persons within every preset time period from a storage device of the electronic device;
determine images from the obtained images which comprise a first person and a second person within every preset time period;
calculate a distance between the first person and the second person in each of the determined images within every preset time period, and calculate a relationship weight between the first person and the second person within every preset time period according to the distance between the first person and the second person in the determined images; and
determine a tendency chart of the relationship weight between the first person and the second person according to the relationship weight between the first person and the second person within every preset time period, and display the tendency chart on a display device of the electronic device.

12. The electronic device according to claim 1, wherein each of the images comprises a time stamp.

13. The electronic device according to claim 12, wherein the time stamp of the image is set according to the time recorded in exchangeable image file format (EXIF) information of the image upon a condition that the image comprises the EXIF information, or set according to the time when the image is uploaded to the storage device upon a condition that the image does not comprise the EXIF information.

14. The electronic device according to claim 11, wherein the determined images which comprise the first person and the second person are determined by:
detecting one or more face blocks in each of the images within every preset time period, and comparing the detected face blocks in each of the images with a first face template of the first person and a second face template of the second person; and
determining that one image comprises the first person and the second person upon a condition that the one image comprises a first face block matching the first face template of the first person and comprises a second face block matching the second face template of the second person.

15. The electronic device according to claim 11, wherein the relationship weight between the first person and the second person is calculated by:
obtaining the determined images in every preset time period, and determining a number “U” of persons in each of the determined images according to detected face blocks in each of the determined images;
calculating a distance “D” between the first person and the second person in each of the determined images;
calculating a relationship strength “E(n)” between the first person and the second person in each of the determined images according to the number “U” of persons in each of the determined images and the distance “D” between the first person and the second person using a preset relationship function “E(n)=1/f(U, D)”; and
calculating a relationship weight between the first person and the second person within every preset time period by totaling the relationship strength “E(n)” between the first person and the second person in each of the determined images within every preset time period.

16. The electronic device according to claim 15, wherein the distance between the first person and the second person is determined to be “n+1” upon a condition that a number of persons between the first person and the second person is “n”.

17. The electronic device according to claim 15, wherein the preset relationship function is “E(n)=1/(U*D)”, and “*” is a multiplication sign.

18. The electronic device according to claim 11, wherein the tendency chart of the relationship weight comprises a movable time block which moves along a horizontal axis of the tendency chart, and the determined images comprising the first person and the second person within the preset time periods corresponding to the movable time block are displayed on the display device according to a preset sequence when the movable time block is moved.

19. The electronic device according to claim 18, wherein a width of the movable time block is adjustable.

20. The electronic device according to claim 11, wherein the plurality of instructions further comprise: calculating a relationship weight between the first person and the second person within every preset time period according to a number of determined images which include the first person and the second person within every preset time period.
